(19) United States
(12) Patent Application Publication
(10) Pub. No.: US 2021/0104347 A1
(43) Pub. Date: Apr. 8, 2021

(54) Housing, Which Contains A Cooling Liquid, Of An Electric Device

(71) Applicant: SIEMENS AKTIENGESELLSCHAFT, MUENCHEN (DE)

(72) Inventor: JOERG FINDEISEN, DRESDEN (DE)

(21) Appl. No.: 16/071,563

(22) PCT Filed: Jan. 13, 2017
(86) PCT No.: PCT/EP2017/050638

§ 371 Date: Jul. 20, 2018

(30) Foreign Application Priority Data
Jan. 20, 2016 (DE) 10 2016 200 742.4

(51) Int. Cl. H01F 27/12; H01F 27/02

(52) U.S. Cl. CPC H01F 27/12; H01F 27/025

(57) ABSTRACT

A housing of an electric device contains a cooling liquid. The housing has at least one barrier in the housing interior. The barrier is impermeable to the cooling liquid and separates a first housing interior region, lying between the barrier and a lateral housing wall of the housing, from a second housing interior region. The barrier is configured to increase a cooling liquid flow of the cooling liquid between the interior regions separated by the barrier in the event that the filling level of the cooling liquid in the housing rises due to the temperature.

The invention relates to a housing, which contains a cooling liquid, of an electric device.

Typical electric devices which are cooled with a cooling liquid are transformers. In this case, the cooling liquid is generally an insulating oil which is contained in a housing of the transformer.

The housing often also serves to cool the cooling liquid in that the housing outer walls absorb heat from the cooling liquid and output it to the surroundings of the housing.

In particular, the invention relates to housings which contain cooling liquids and have corrugated walls. Corrugated walls are undulating housing walls which have elastically deformable wall corrugations. By virtue of the elastic deformability of the wall corrugations, corrugated walls can absorb temperature-dependent fluctuations in volume of a cooling liquid which is contained in the housing. As result of the wall corrugations, corrugated walls also have a larger surface and as a result a greater cooling effect than non-corrugated walls.

A housing containing a cooling liquid can be hermetically sealed or embodied in a breathing fashion. In hermetically sealed housings, temperature-dependent fluctuations in the volume of the cooling liquid cause pressure fluctuations. Therefore, hermetically sealed housings must be configured in a pressure-proof fashion. A breathing housing is understood to be a housing which has a gas opening through which gas (generally air) can flow into the housing interior and out of the housing interior, in order to avoid such pressure fluctuations in the housing. However, breathing housings have the disadvantage that gas which flows into the housing interior generally contains moisture. In a typical case in which the cooling liquid is an insulating oil, this moisture which enters through the gas brings about a continuous rise in a moisture content of the insulating oil, which rise adversely effects the cooling effect and electrical insulating effect of the insulating oil. In order to reduce the entry of moisture into the housing interior, gas-dehumidifiers are therefore frequently arranged at gas openings of breathing housings.

The invention is based on the object of specifying a housing of an electric device which, in particular, is improved in respect of its cooling effect and which contains a cooling liquid.

The object is achieved according to the invention by means of the features of claim 1.

Advantageous refinements of the invention are the subject matter of the dependent claims.

An inventive housing, containing a cooling liquid, of an electric device, comprises at least one barrier which is impermeable to the cooling liquid, which separates a first interior region, bounded by said barrier and a lateral housing outer wall of the housing, of the housing interior, from a second interior region of the housing interior, and is embodied in such a way that it increases a cooling liquid flow of the cooling liquid between the interior regions which are separated by said barrier in the event of a temperature-induced rise in a filling level of the cooling liquid in the housing.

The invention is based on the concept of increasing the cooling effect of a lateral housing outer wall of the housing when the temperature of the cooling liquid in the housing rises. For this purpose, a barrier by which a cooling liquid flow is increased to the housing outer wall in the event of a temperature-induced rise in a filling level of the cooling liquid in the housing is arranged in the housing interior. The barrier is also embodied in such a way that at high temperatures it permits a large cooling liquid flow to the housing outer wall and therefore brings about a large cooling effect of the housing outer wall, whereas at low temperatures it entirely prevents or considerably reduces the cooling liquid flow to the housing outer wall and as a result correspondingly limits the cooling effect of the housing outer wall. As a result, the cooling effect of the lateral housing outer wall of the temperature of the cooling liquid is advantageously adapted in a structurally particularly simple and cost-effective fashion. At high temperatures, the barrier permits a good cooling of the cooling liquid and of the electric device arranged in the housing. At low temperatures, the barrier permits more rapid heating of the cooling liquid owing to the reduced cooling effect of the housing outer wall, therefore permitting a better cooling starting behavior and more rapid powering up of the electric device to an optimum operating temperature. Therefore, it becomes possible, for example, to operate an alternating load mode even at artic temperatures, since now the no-load operation losses give rise to heating of the transformer during which the viscosity of the insulating liquid drops to values permitting it to circulate. This avoids the formation of dangerous local hot spots in the winding when load changes occur. This is advantageous, in particular, in transformers which are filled with insulating liquids based on natural or synthetic esters, since the viscosity of these liquids is significantly higher than in insulating liquids based on mineral oil.

One refinement of the invention provides that at least one wall section, bounding a first interior region, of a lateral housing outer wall is embodied as a corrugated wall. In this context, at least one corrugated wall can have at least one wall corrugation with a housing-interior-side corrugation crest which is fixedly connected to a barrier. Corrugated walls advantageously permit temperature-dependent fluctuations in volume of the cooling liquid which is contained in the housing to be absorbed and as a result pressure fluctuations which are caused in the housing to be reduced. Furthermore, corrugated walls have, by virtue of their corrugated shape a larger surface and therefore a larger cooling effect than non-corrugated walls. As a result of a fixed connection of a barrier to at least one housing-interior-side corrugation crest of a corrugated wall the barrier advantageously increases the strength of the housing.

A further refinement of the abovementioned refinement of the invention provides at least one barrier which separates from one another two interior regions, each bounded by side walls, lying opposite one another, of a wall corrugation, wherein the two interior regions are connected to one another above and below the barrier. This refinement of the invention therefore provides at least one barrier which is arranged inside a wall corrugation and which divides an interior region surrounded by the wall corrugation. As a result, the large outer surface of the wall corrugation can be advantageously used for particularly effective control of the cooling of the cooling liquid by the barrier. Furthermore, the barrier can also advantageously contribute to the stability of the wall corrugation.

A further refinement of the invention provides at least two barriers which are arranged one behind the other and which separate from one another a plurality of interior regions of the housing interior. In this case, the interior regions are connected to one another above and below the barriers, and the barriers have barrier levels which are different from one another and which increase toward an outer side of the housing. This refinement advantageously permits stepwise integration of interior regions, arranged one behind the other, of the housing interior for cooling the cooling liquid and therefore a further improvement in the temperature dependence of the cooling of the cooling liquid.

A further refinement of the invention provides that at least one barrier has at least one barrier opening at such an opening level that a part of the barrier opening which is dependent on the temperature of the cooling liquid lies below the filling level of the cooling liquid in the housing.

A further refinement of the invention provides that at least one barrier has an upper edge, above which cooling liquid can flow between the interior regions which are separated by the barrier, and a lower edge, below which cooling liquid can flow between the interior regions which are separated by the barrier. In this context, the barrier has a vertical profile which varies along the upper edge, with the result that a part of the upper edge which is dependent on the temperature of the cooling liquid lies below the filling level of the cooling liquid in the housing. In addition, the vertical profile of at least one barrier can drop, for example, away from a central region of the upper edge to at least one end of the upper edge or can rise monotonously from a first end of the upper edge to a second end of the upper edge.

The two abovementioned refinements of the invention advantageously permit a cooling liquid flow over the barrier and/or through the barrier openings to be regulated in a variable fashion as a function of the temperature of the cooling liquid, by means of a suitable varying vertical profile and/or suitable barrier openings of a barrier.

A further refinement of the invention provides that a first housing height of a first housing region, containing at least one barrier, of the housing is greater than a minimum filling level of the cooling liquid in the housing, and a second housing height of at least a second housing region is smaller than the minimum filling level of the cooling liquid in the housing. In this context, a cover region of at least a second housing region can have at least one cooling-liquid-tight feed through for at least one electrical line into the housing interior, wherein the part of the feed through which projects into the housing interior of the housing and the electrical line run completely below the minimum filling level of the cooling liquid. The minimum filling level of the cooling liquid in the housing is here a filling level which is assumed by a liquid level of the cooling liquid at a defined minimum temperature for which the electric device is designed. This refinement of the invention advantageously permits that the cooling liquid always fills at least one housing region of the housing completely, i.e. up to the housing cover, with the result that in this housing region no volume which is filled by gas such as air between the housing cover and the cooling liquid level is formed. As a result, feedthroughs for electrical lines can be arranged in this housing region, so that the electrical lines which are conducted through the feedthroughs are electrically insulated in the housing interior by the cooling liquid if the cooling liquid is, for example, an insulating oil.

A further refinement of the invention provides at least one gas opening which is arranged above a maximum filling level of the cooling liquid in the housing and through which gas can flow into the housing interior and can flow out of the housing interior as a function of a pressure in the housing interior. In this context, preferably at least one gas dehumidifier for dehumidifying gas flowing through a gas opening into the housing interior is provided. The maximum filling level of the cooling liquid in the housing is here a filling level which is assumed by the cooling liquid level of the cooling liquid at a defined maximum temperature for which the electric device is configured. This refinement of the invention implements a breathing housing, by which pressure fluctuations in the housing, which are caused by temperature-dependent fluctuations in the volume of the cooling liquid, are advantageously avoided. Gas dehumidifiers advantageously reduce here the ingress of moisture, which adversely effects the cooling and insulating effect of the cooling liquid, into the housing interior as result of the inflowing gas.

An alternative refinement of the invention provides that the housing is closed off hermetically. This advantageously avoids moisture from penetrating the housing interior as a result of inflowing gas. As a result of the embodiment of housing outer walls as corrugated walls and as a result of the cooling effect of the housing outer walls which is improved by the barriers it is possible to reduce pressure fluctuations which occur here in hermetically closed-off housings and which are brought about by temperature-dependent fluctuations in volume of the cooling liquid in the housing.

A further refinement of the invention provides that at least one barrier is fabricated from an electrically insulating material. As a result, the barrier also advantageously acts as an electrical barrier with respect to a housing outer wall.

In a further refinement of the invention there is provision that at least one barrier is embodied at least partially as a magnetic shield for the flux leakage of a winding of the electric device. This is advantageously achieved by fabricating at least some of the barrier from a magnetizable material. In this context, a plurality of packets which are composed of a laminated electrical sheet are attached to the inside of the corrugated wall. The barrier can therefore be used to reduce additional losses and to avoid excessive heating of the housing caused by eddy currents.

The invention provides, in particular, a transformer with a housing according to the invention.

The properties, features and advantages of this invention which are described above and the way in which these are achieved become clearer and more easily understood in conjunction with the following description of exemplary embodiments which are explained in more detail in conjunction with the drawings, in which:

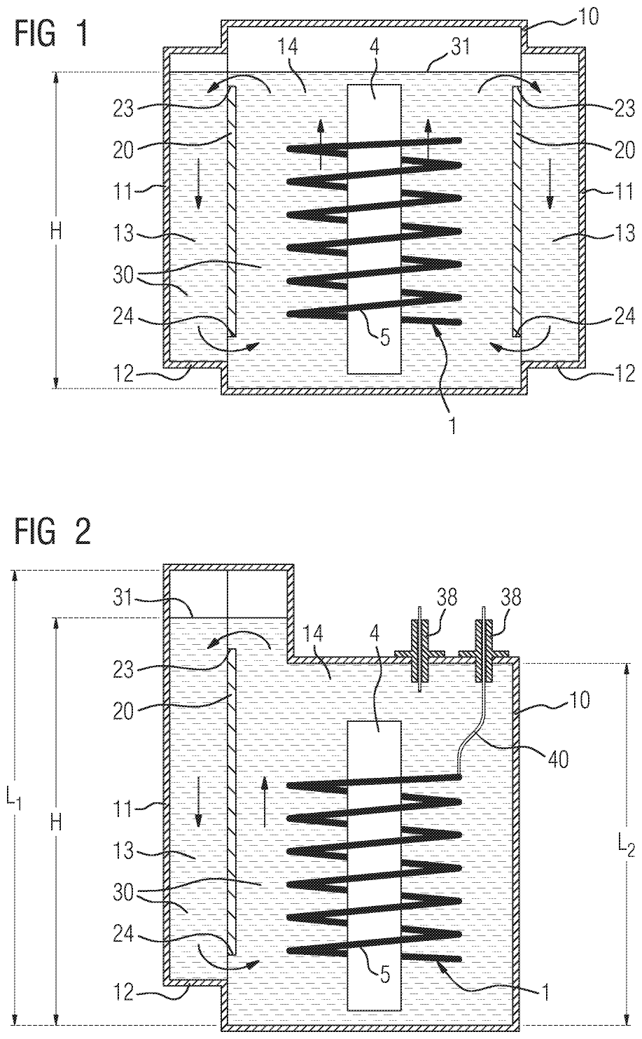

FIG. 1 shows a sectional illustration of a first exemplary embodiment of a housing, containing a cooling liquid, of an electric device,

FIG. 2 shows a sectional illustration of a second exemplary embodiment of a housing, containing a cooling liquid, of an electric device,

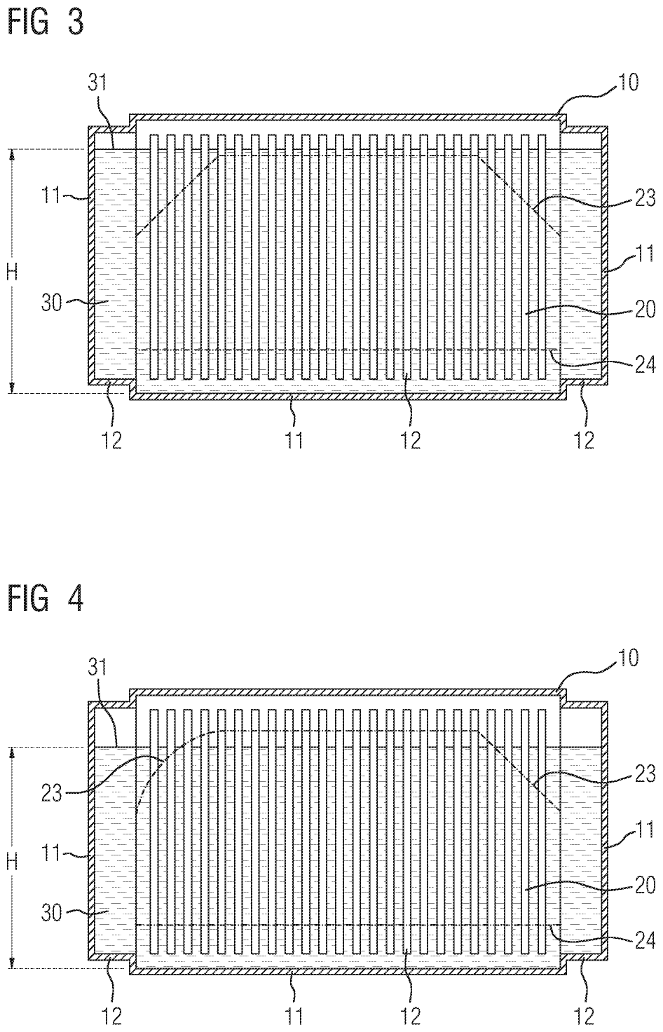

FIG. 3 shows a side view of a third exemplary embodiment of a housing, containing a cooling liquid, of an electric device,

FIG. 4 shows a side view of a fourth exemplary embodiment of a housing, containing a cooling liquid, of an electric device,

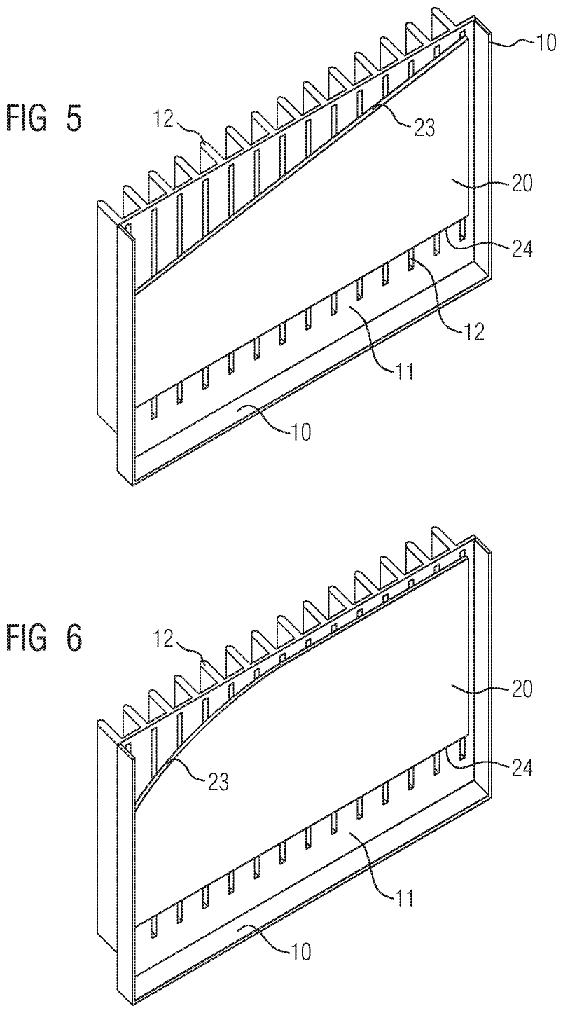

FIG. 5 shows a perspective illustration of a housing outer wall and of a barrier of a fifth exemplary embodiment of a housing, containing a cooling liquid, of an electric device,

FIG. 6 shows a perspective illustration of a housing outer wall and of a barrier of a sixth exemplary embodiment of a housing, containing a cooling liquid, of an electric device,

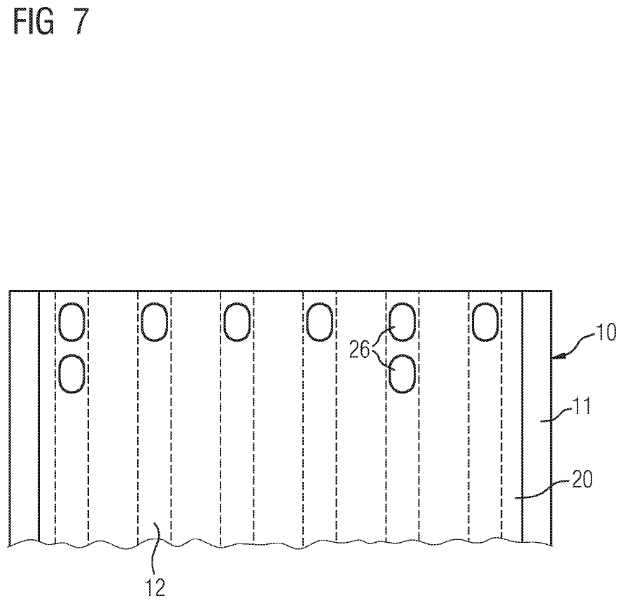

FIG. 7 shows a plan view of a barrier in front of a lateral housing outer wall of a seventh exemplary embodiment of a housing, containing a cooling liquid, of an electric device,

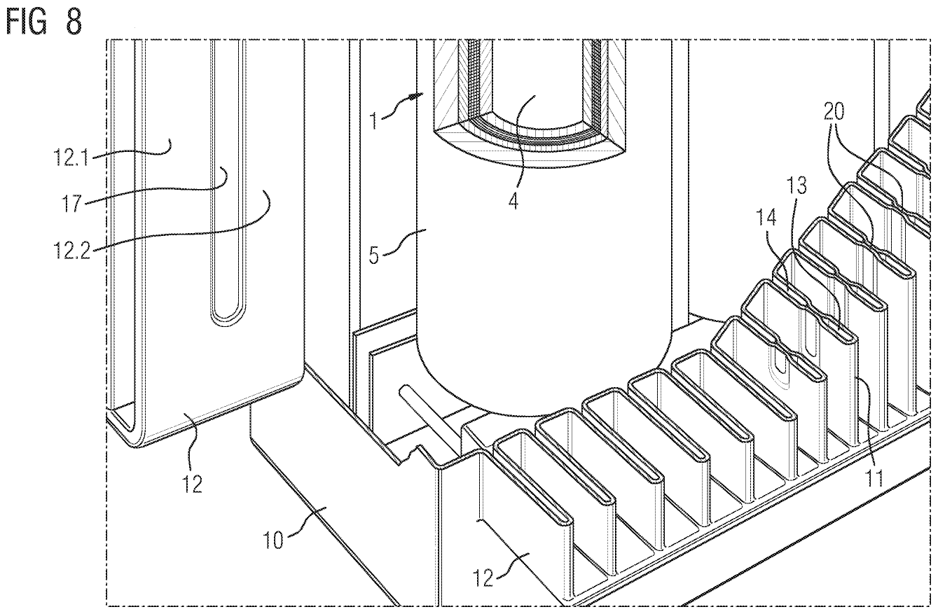

FIG. 8 shows a detail of a perspective illustration of an eighth exemplary embodiment of a housing, containing a cooling liquid, of an electric device,

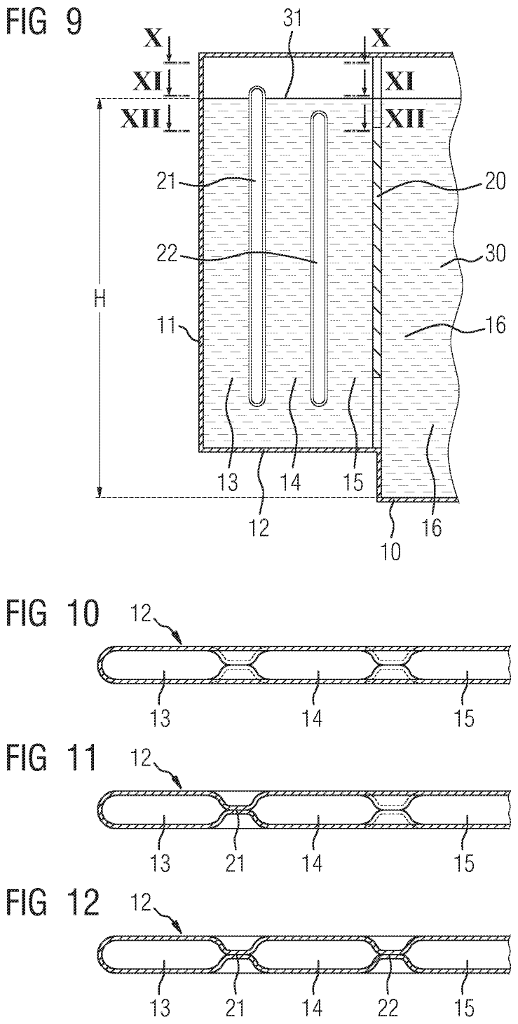

FIG. 9 shows a detail of a first sectional illustration of a ninth exemplary embodiment of a housing, containing a cooling liquid, of an electric device,

FIG. 10 shows a detail of a second sectional illustration of the ninth exemplary embodiment of a housing, containing a cooling liquid, of an electric device,

FIG. 11 shows a detail of a third sectional illustration of the ninth exemplary embodiment of a housing, containing a cooling liquid, of an electric device,

FIG. 12 shows a detail of a fourth sectional illustration of the ninth exemplary embodiment of a housing, containing a cooling liquid, of an electric device,

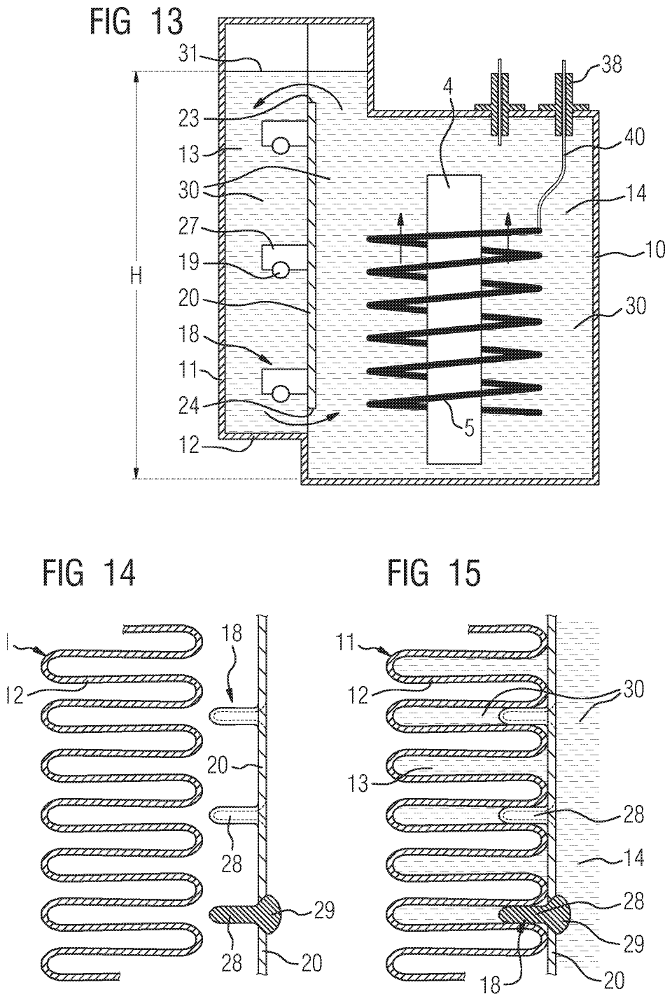

FIG. 13 shows a sectional illustration of a tenth exemplary embodiment of a housing, containing a cooling liquid, of an electric device,

FIG. 14 shows a detail of a first sectional illustration of an eleventh exemplary embodiment of a housing, containing a cooling liquid, of an electric device, and

FIG. 15 shows a detail of a second sectional illustration of the eleventh exemplary embodiment of a housing, containing a cooling liquid, of an electric device.

Corresponding parts are provided with the same reference symbols in all the figures.

FIG. 1 shows a sectional illustration of a first exemplary embodiment of a housing 10, containing a cooling liquid 30, of an electric device 1.

The electric device 1 is a transformer which is illustrated only schematically and has a transformer core 4 and a transformer winding 5. The cooling liquid 30 is, for example, an insulating oil for electrically insulating the transformer winding 5 and for cooling the transformer.

The housing 10 has lateral housing outer walls 11 which are embodied as corrugated walls with vertically running wall corrugations 12 (see in this respect also FIGS. 3 to 6). Barriers 20 which are impermeable to the cooling liquid 30 are arranged in a housing interior. Each barrier 20 separates a first interior region 13, lying between it and a housing outer wall 11 embodied as a corrugated wall, of the housing interior from a second interior region 14 of the housing interior. The first interior regions 13 are edge regions of the housing interior, and the second interior region 14 is a central region of the housing interior in which the electric device 1 is arranged.

Each barrier 20 is embodied in such a way that it influences a cooling liquid flow of the cooling liquid 30, indicated by arrows in FIG. 1, between the interior regions 13, 14 separated by said barrier 20, as a function of a temperature-dependent filling level H of the cooling liquid 30 in the housing 10. For this purpose, the barrier 20 is embodied and arranged in such a way that cooling liquid 30 can flow between the interior regions 13, 14 separated by the barrier 20, below a lower edge 24 of the barrier 20 and above an upper edge 23 of the barrier 20 when there is a sufficient filling level H. In this context, at low temperatures of the cooling liquid 30 the upper edge 23 of each barrier 20 lies entirely or partially above the filling level H, while at relatively high temperatures it lies below the filling level H entirely or to a greater extent than at low temperatures. In particular, the barrier 20 can have a vertical profile which varies along the upper edge 23, so that a part of upper edge 23 which is dependent on the temperature of the cooling liquid 30 lies below the filling level H of the cooling liquid 30 in the housing 10, see in this respect FIGS. 3 to 6.

The filling level H of the cooling liquid 30 in the housing 10 is a distance of a cooling liquid level 31 of the cooling liquid 30 from a housing floor of the housing 10.

In the state illustrated in FIG. 1, the temperature of the cooling liquid 30 is so high that at least part of the upper edge 23 of each barrier 20 lies below the filling level H of the cooling liquid 30. In this state, cooling liquid 30 which is heated by the transformer winding 5 flows upward in the second interior region 14 and over the upper edges 23 of the barriers 20 into the first interior regions 13. In each first interior region 13, the cooling liquid 30 cools down again, and as result flows downward and under the lower edge 24 of the barrier 20 bounding the first interior region 13, into the second interior region 14. As the temperature of the cooling liquid 30 decreases, the filling level H of the cooling liquid 30 drops. As a result, the cooling liquid flows above the upper edges 23 of the barriers 20 from the second interior region 14 into the first interior regions 13 are also reduced. If the temperature of the cooling liquid 30 drops so far that the upper edges 23 lie completely above the filling level H, cooling liquid 30 can no longer flow above the upper edges 23 from the second interior region 14 into the first interior regions 13.

As a result, the barriers 20 influence the cooling effect of the housing outer walls 11 as a function of the temperature of the cooling liquid 30, wherein said barriers advantageously increase the cooling effect when the temperature rises.

FIG. 2 shows a sectional illustration of a second exemplary embodiment of a housing 10, containing a cooling liquid 30, of an electric device 1.

The electric device 1 in turn has a transformer (illustrated only schematically), a transformer core 4 and a transformer winding 5, and the cooling liquid 30 is, for example, an insulating oil for electrically insulating the transforming winding 5 and cooling the transformer.

The housing 10 has a lateral housing outer wall 11 which is embodied as a corrugated wall with vertically running wall corrugations 12 (see in this respect also FIGS. 3 to 6). In a housing interior, a barrier 20 which is impermeable to the cooling liquid 30 is arranged. The barrier 20 separates a first interior region 13, lying between it and the housing wall 11 which is embodied as a corrugated wall, of the housing interior from a second interior region 14, containing the electric device 1, of the housing interior.

The barrier 20 is embodied in such a way that it influences a cooling liquid flow, indicated by arrows in FIG. 2, of the cooling liquid 30 between the interior regions 13, 14 separated by it, as a function of a temperature-dependent filling level H of the cooling liquid 30 in the housing 10. For this purpose, the barrier 20 is embodied and arranged in such a way that cooling liquid 30 can flow below a lower edge 24 of the barrier 20, and given a sufficient filling level H above an upper edge 23 of the barrier 20, between the interior regions 13, 14 which are separated by the barrier 20. In this context, at low temperatures of the cooling liquid 30 the upper edge 23 of the barrier 20 lies entirely or partially above the filling level H, while at relatively high temperatures it lies below the filling level H entirely or to a greater extent than at low temperatures. In particular, the barrier 20 can have a vertical profile which varies along the upper edge 23, with the result that a part of the upper edge 23 which is dependent on the temperature of the cooling liquid 30 lies below the filling level H of the cooling liquid 30 in the housing 10, see in this respect FIGS. 3 to 6.

In the state illustrated in FIG. 2, the temperature of the cooling liquid 30 is so high that at least part of the upper edge 23 of the barrier 20 is below the filling level H of the cooling liquid 30. In this state, cooling liquid 30 which is heated by the transformer winding 5 flows upward into the second interior region 14 and into the first interior region 13 via the upper edge 23 of the barrier 20.

In the first interior region 13, the cooling liquid 30 cools down again, and as a result flows downward and under the lower edge 24 of the barrier 20 into the second interior region 14. As the temperature of the cooling liquid 30 decreases, the filling level H of the cooling liquid 30 drops. As a result, the cooling liquid flow above the upper edge 23 of the barrier 20 from the second interior region 14 into the first interior region 13 is also reduced. If the temperature of the cooling liquid 30 drops so far that the upper edge 23 lies completely above the filling level H, cooling liquid 30 can no longer flow above the upper edge 23 from the second interior region 14 into the first interior region 13.

As a result, the barrier 20 influences the cooling effect of the housing outer wall 11 as a function of the temperature of the cooling liquid 30, wherein it advantageously increases the cooling effect when the temperature rises.

A first housing height L₁ of a first housing region, containing the barrier 20, of the housing 10 is higher than a minimum filling level of the cooling liquid 30 in the housing 10, and a second housing height L₂ of at least one second housing region is lower than the minimum filling level of the cooling liquid 30 in the housing 10. The minimum filling level of the cooling liquid 30 in the housing 10 is here a filling level H which is assumed by the cooling liquid level 31 of the cooling liquid 30 at a defined minimum temperature for which the electric device 1 is configured. A cover region of the second housing region has cooling-liquid-tight feedthroughs 38 for, in each case, an electrical line 40 into the housing interior. A cover region of the first housing region has a cross-sectional area which is significantly smaller than an overall cross-sectional area of the cover region of the housing 10, in particular smaller than half this overall cross-sectional area, in order to bring about large changes of the filling level H of the cooling liquid 30 when temperature fluctuations occur. As a result, the dependence of the cooling of the cooling liquid 30 on the temperature of the cooling liquid 30 is advantageously increased.

FIG. 3 shows a side view of a third exemplary embodiment of a housing 10, containing a cooling liquid 30, of an electric device 1.

The housing 10 has lateral housing outer walls 11 which are embodied as corrugated walls with vertically running wall corrugations 12 (see in this respect also FIGS. 5 and 6). Barriers 20 which are impenetrable to the cooling liquid 30 are arranged in a housing interior. Each barrier 20 separates, in a way analogous to the exemplary embodiments illustrated in FIGS. 1 and 2, a first interior region 13, lying between it and a housing outer wall 11 embodied as a corrugated wall, of the housing interior from a second interior region 14 of the housing interior.

One of the barriers 20 is indicated in FIG. 3. The barrier 20 is embodied and arranged in such a way that cooling liquid 30 can flow underneath a lower edge 24 of the barrier 20 and, given a sufficient filling level H, above an upper edge 23 of the barrier 20, between the interior regions 13, 14 which are separated by the barrier 20. In this context, at low temperatures of the cooling liquid 30 the upper edge 23 of each barrier 20 lies entirely or partially above the filling level H, while at relatively high temperatures it lies below the filling level H entirely or to a greater extent than at low temperatures. The barrier 20 has a vertical profile which varies along the upper edge 23 and has a constant level in a central region of the upper edge 23 and drops linearly toward each end of the upper edge 23.

In the state illustrated in FIG. 3, the temperature of the cooling liquid 30 is so high that the upper edge 23 of the barrier 20 lies completely below the filling level H of the cooling liquid 30. As the temperature of the cooling liquid 30 decreases, the filling level H of the cooling liquid 30 drops, with the result that, as in FIG. 4, only a part of the upper edge 23 which is dependent on the temperature of the cooling liquid 30 and finally the entire upper edge 23 still lie below the filling level H.

The barriers 20 influence, in a way analogous to the descriptions of FIGS. 1 and 2 above, the cooling effect of the housing outer walls 11 as a function of the temperature of the cooling liquid 30, wherein they advantageously increase the cooling effect when the temperature rises.

FIG. 4 shows a side view of a fourth exemplary embodiment of a housing 10, containing a cooling liquid 30, of an electric device 1. This exemplary embodiment differs from the exemplary embodiment illustrated in FIG. 3 only in respect of the shape of the vertical profiles of the barriers 20. As in the exemplary embodiment illustrated in FIG. 3, each vertical profile has a constant level in a central region of the upper edge 23 and drops toward each end of the upper edge 23. However, in contrast to the exemplary embodiment illustrated in FIG. 3, the drop is linear only toward one end of the upper edge 23, while it has a convexly curved progression at the other end.

The FIGS. 5 and 6 each show a perspective illustration of a lateral housing outer wall 11 and of a barrier 20 according to further exemplary embodiments of a housing 10, containing a cooling liquid 30 (not illustrated in FIGS. 5 and 6) of an electric device 1. These exemplary embodiments are each analogous to one of the exemplary embodiments illustrated in FIGS. 1 to 4, wherein the barriers 20 each have a vertical profile which varies along the upper edge 23 and which rises monotonously from a first end of the upper edge 23 to a second end of the upper edge 23. In this context, the rise in the exemplary embodiment illustrated in FIG. 5 is linear, while it has a convexly curved region in the exemplary embodiment illustrated in FIG. 6.

FIG. 7 shows a plan view of a barrier 20 in front of a lateral housing outer wall 11 of a further exemplary embodiment of a housing 10, containing a cooling liquid 30 (not illustrated in FIG. 7) of an electric device 1. The housing outer wall 11 is in turn embodied as a corrugated wall with wall corrugations 12. The barrier 20 has a plurality of barrier openings 26. Each barrier opening 26 is located in the region of a wall corrugation 12 at an opening level which is selected such that a part of the barrier opening 26 which is dependent on the temperature of the cooling liquid 30 lies below the filling level H of the cooling liquid 30 in the housing 10. A plurality of barrier openings 26 can also be arranged in particular in the region of a wall corrugation 12.

FIG. 8 shows a detail of a perspective illustration of a further exemplary embodiment of a housing 10, containing a cooling liquid 30 (not illustrated in FIG. 8) of an electric device 1, wherein the housing 10 is illustrated in broken-open form for the sake of better clarification. The electric device 1 is a transformer with a transformer core 4 and a transformer winding 5. The housing 10 has lateral housing outer walls 11 which are embodied as corrugated walls with vertically running wall corrugations 12. Some or all of the wall corrugations 12 have barriers 20. Each barrier 20 separates here from one another two interior regions 13, 14 which are each bounded by side walls, lying opposite one another, of a wall corrugation 12, wherein a first interior region 13 is surrounded by an outer region 12.1 of the wall corrugation 12, and the second interior region 14 is surrounded by an inner region 12.2 of the wall corrugation 12. The two interior regions 13, 14 are connected to one another above and below the barriers 20, with the result that cooling liquid 30 can flow between the interior regions 13, 14.

The barrier levels of the barriers 20 are adapted here to the temperature-dependent filling level H of the cooling liquid 30, with the result that an upper end of a barrier 20 lies above or below the filling level H as a function of the temperature of the cooling liquid 30. In this context, the barrier levels of the barriers 20 can be different from one another, with the result that a number of these upper ends which is dependent on the temperature of the cooling liquid 30 is below the filling level H. Each barrier 20 connects the outer region 12.1 and the inner region 12.2 of a wall corrugation 12 in a web-like fashion in the region of vertically running beads 17, lying opposite one another, in the outer surfaces of the side walls of the wall corrugation 12. As a result, the barrier 20 advantageously increases the stability of the wall corrugation 12.

FIGS. 9 to 12 show details of sectional illustrations of a further exemplary embodiment of a housing 10, containing a cooling liquid 30, of an electric device 1. In this context, FIG. 9 shows a longitudinal sectional illustration in a sectional plane which contains a vertical axis of the housing 10, and FIGS. 10 to 12 show cross-sectional illustrations in cross-sectional planes, perpendicular to the vertical axis, at various levels.

The housing 10 has a lateral housing outer wall 11 which is embodied as a corrugated wall with vertically running wall corrugations 12. A first barrier 21 and a second barrier 22, which each run vertically, are arranged one behind the other in each wall corrugation 12, and separate from one another three interior regions 13, 14, 15, each bounded by side walls, lying opposite one another, of the wall corrugation 12, of the housing interior. The first and second barriers 21, 22 are each formed as barriers 20 of the exemplary embodiment illustrated in FIG. 8. In particular, the interior regions 13, 14, 15 of each wall corrugation 12 are connected to one another above and below the barriers 21, 22. FIG. 9 shows a wall corrugation 12 and barriers 21, 22 in a longitudinal section, and FIGS. 10 to 12 show cross-sectional illustrations of the wall corrugation 12 at various levels.

A third barrier 20 is arranged along the entire corrugated wall and separates the interior regions 13, 14, 15, lying in the wall corrugations 12, from an adjoining further interior region 16. The third barrier 20 is embodied in an analogous fashion to a barrier 20 of one of the exemplary embodiments illustrated in FIGS. 1 to 6. Above and below the third barrier 20, the interior region 16 is connected to the interior regions 13, 14, 15 lying in the wall corrugations 12.

The barriers 20, 21, 22 have barrier levels which are different from one another and which increase toward a housing outer side, i.e. the first barrier 21 has a greater barrier level than the second barrier 22, and the second barrier 22 has a greater barrier level than the third barrier 20. The barrier levels are adapted to the temperature-dependent filling level H of the cooling liquid 30, with the result that at very low temperatures the filling level H is lower than the barrier level of the third barrier 20, and as the temperature increases it firstly exceeds the barrier level of the third barrier 20, then the barrier level of the second barrier 22 and finally the barrier level of the first barrier 21. As a result, as the temperature rises an increasing number of the interior regions 13, 14, 15 which lie in the wall corrugations 12 and an increasing outer surface of the corrugated wall take part in the cooling of the cooling liquid 30, with the result that the cooling effect of the corrugated wall rises as the temperature increases.

FIG. 13 shows a sectional illustration of a further exemplary embodiment of a housing 10, containing a cooling liquid 30, of an electric device 1. This exemplary embodiment differs from the exemplary embodiment shown in FIG. 2 only in that the barrier 20 is connected by means of a clamping connection 18 to the housing outer wall 11 which is embodied as a corrugated wall. The clamping connection 18 comprises a plurality of locking webs 19 which are arranged on the inside of the corrugated wall and a plurality of clamping mounts 27 which are arranged on the barrier 20, corresponding to the locking webs 19 and with which the barrier 20 is attached to the locking webs 19.

FIGS. 14 and 15 show an alternative to the clamping connection 18 (illustrated in FIG. 13) of a barrier 20 on a housing outer wall 11, embodied as a corrugated wall, in each case in a sectional illustration. In this context, FIG. 14 shows the barrier 20 and the corrugated wall before the attachment of the barrier 20, and FIG. 15 shows the barrier 20 and the corrugated wall after the attachment of the barrier 20. In the exemplary embodiment illustrated in FIGS. 14 and 15, the clamping connection 18 has elastically deformable clamping projections 28 which are arranged on the barrier 20 and which each latch into a wall corrugation 12 in order to attach the barrier 20. The clamping projections 28 can either be fixedly or detachably arranged on the barrier 20. A clamping projection 28 which is detachably arranged on the barrier 20 has, for example, an attachment head 29 and is guided through an attachment opening in the barrier 20, with the result that the attachment head 29 bears on a side, facing away from the housing outer wall 11, on the barrier 20. FIGS. 14 and 15 illustrate an exemplary embodiment with clamping projections 28 which are fixedly and detachably arranged on the barrier 20. Alternatively, the attachment device can also have clamping projections 28 which are connected either only detachably or only fixedly to the barrier 20.

In all the exemplary embodiments illustrated in FIGS. 1 to 7 and 9 to 12, the respectively illustrated housing outer wall 11, which is embodied as a corrugated wall, can have at least one wall corrugation 12 with a corrugation crest which is on the inside of the housing and is fixedly connected to a barrier 20. As a result, the barrier 20 also increases the strength of the housing 10.

In all the exemplary embodiments illustrated in FIGS. 1 to 15, at least one barrier 20 can also be fabricated from an electrically insulating material, so that the barrier 20 also has an electrical barrier effect for a housing outer wall 11.

In addition, the housing 10 can be embodied in all the exemplary embodiments illustrated in FIGS. 1 to 15 in either a breathing or hermetically sealed fashion. A housing 10 which is embodied in a breathing fashion has at least one gas opening which is arranged in the housing 10 above a maximum filling level of the cooling liquid 30, through which gas opening the gas can flow into the housing interior and out of the housing interior as a function of a pressure in the housing interior. In this context, a gas dehumidifier for dehumidifying gas flowing into the housing interior through the gas opening is preferably arranged at the gas opening.

Although the invention has been illustrated and described in detail by means of preferred exemplary embodiments, the invention is not restricted by the disclosed examples, and other variations can be derived therefrom by a person skilled in the art without departing from the scope of protection of the invention.

### LIST OF REFERENCE SYMBOLS

1 Electric device
4 Transformer core
5 Transformer winding
10 Housing
11 Housing outer wall
12 Wall corrugation
12.1 Outer region
12.2 Inner region
13 to 16 Interior region
17 Bead
18 Clamping connection
19 Locking web
20, 21, 22 Barrier
23 Upper edge
24 Lower edge
26 Barrier opening
27 Clamping mount
28 Clamping projection
29 Attachment head
30 Cooling liquid
31 Cooling liquid level
38 Feedthrough
40 Electrical line
H Filling level
L₁ First housing height
L₂ Second housing height

1-15. (canceled)

16. A housing of an electric device, the housing comprising
at least one barrier that is impermeable to a cooling liquid contained in the housing;
said at least one barrier separating a first interior region of a housing interior from a second interior region of the housing interior, said first interior region being bounded by said barrier and a lateral housing outer wall of the housing;
said at least one barrier being configured to increase a cooling liquid flow of the cooling liquid between said first and second interior regions that are separated by said barrier in an event of a temperature-induced rise in a filling level of the cooling liquid in the housing.

17. The housing according to claim 16, wherein at least one wall section, bounding said first interior region, of the lateral housing outer wall is a corrugated wall.

18. The housing according to claim 17, wherein the corrugated wall has at least one wall corrugation with a housing-interior-side corrugation crest that is fixedly connected to said barrier.

19. The housing according to claim 17, wherein said at least one barrier separates from one another two interior regions, each bounded by side walls, lying opposite one another, of a wall corrugation, of the housing interior, wherein the two interior regions are connected to one another above and below said barrier.

20. The housing according to claim 16, wherein said barrier is one of at least two barriers that are arranged one behind another and which separate from one another a plurality of interior regions of the housing interior, wherein the interior regions are connected to one another above and below said barriers, and said barriers have barrier levels that are different from one another and which increase outwardly toward an outer side of the housing.

21. The housing according to claim 16, wherein at least one barrier has at least one barrier opening at such an opening level that a part of the barrier opening which is dependent on the temperature of the cooling liquid lies below the filling level of the cooling liquid in the housing.

22. The housing according to claim 16, wherein at least one said barrier has an upper edge disposed to enable cooling liquid to flow between the interior regions which are separated by said barrier, and a lower edge disposed to enable cooling liquid to flow between the interior regions which are separated by said barrier, wherein said barrier has a vertical profile which varies along the upper edge, with the result that a part of the upper edge which is dependent on the temperature of the cooling liquid lies below the filling level of the cooling liquid in the housing.

23. The housing according to claim 22, wherein the vertical profile of at least one barrier drops away from a central region of the upper edge to at least one end of the upper edge.

24. The housing according to claim 22, wherein the vertical profile of at least one barrier rises monotonously along the upper edge thereof, from a first end of the upper edge to a second end of the upper edge.

25. The housing according to claim 16, wherein a first housing height of a first housing region, containing at least one barrier, of the housing is greater than a minimum filling level of the cooling liquid in the housing, and a second housing height of at least a second housing region is smaller than the minimum filling level of the cooling liquid in the housing.

26. The housing according to claim 25, wherein a cover region of at least a second housing region is formed with a cooling-liquid-tight feed through for at least one electrical line into the housing interior, wherein a part of said feed through which projects into the housing interior of the housing and the electrical line run completely below a minimum filling level of the cooling liquid.

27. The housing according to claim 16, formed with at least one gas opening which is arranged above a maximum filling level of the cooling liquid in the housing and configured to enable gas to flow into the housing interior and to flow out of the housing interior as a function of a pressure in the housing interior.

28. The housing according to claim 16, wherein the housing is a hermetically closed off housing.

29. The housing according to claim 16, wherein said at least one barrier is fabricated from an electrically insulating material.

30. A transformer, comprising a housing according to claim 16.
